(19) United States
(12) Patent Application Publication
(10) Pub. No.: US 2010/0254631 A1
(43) Pub. Date: Oct. 7, 2010

(54) PEER-TO-PEER FILE SHARING SYSTEM AND METHOD

(75) Inventors: Chia-Hung CHIEN, Tu-Cheng (TW); Chun-Wen WANG, Tu-Cheng (TW); Tun-Tao TSAI, Tu-Cheng (TW); Liang-Mao HUNG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/479,961

(22) Filed: Jun. 8, 2009

(30) Foreign Application Priority Data
Apr. 3, 2009 (CN) 200910301345.X

(51) Int. Cl. G06K 9/54; G06F 17/30; G06F 15/16

(52) U.S. Cl. 382/305; 709/203; 707/E17.01

(57) ABSTRACT

A peer-to-peer file sharing system includes a first digital photo frame connected to a network, a second digital photo frame connected to the network, and a server connected to the network. A plurality of files is stored in the first digital photo frame. An address information of the second digital photo frame is stored in the server. The first digital photo frame is capable of acquiring the address information of the second digital photo frame from the server, and transmitting the files to the second digital photo frame directly based on the address information.

### BACKGROUND

1. Technical Field

The present disclosure relates to a peer-to-peer file sharing system and method between electronic devices.

2. Description of Related Art

Digital photo frames (DPF) are becoming increasingly popular due to the convenience and ease of manipulation when browsing media files stored therein. When a user of the DPF wants to share a private media file with others, the media file must be uploaded to a remote public server in the Internet. Then the others can download the media file from the remote public server to their DPFs for browsing. However, the private media file will be exposed in the Internet, and it is insecure.

What is needed, therefore, is a peer-to-peer file sharing system and method between electronic devices.

### BRIEF DESCRIPTION OF THE DRAWINGS

FIG. 1 to FIG. 4 are schematic diagrams of an embodiment of a peer-to-peer file sharing system.

FIG. 5 is a flow chart of an embodiment of a peer-to-peer file sharing method.

### DETAILED DESCRIPTION

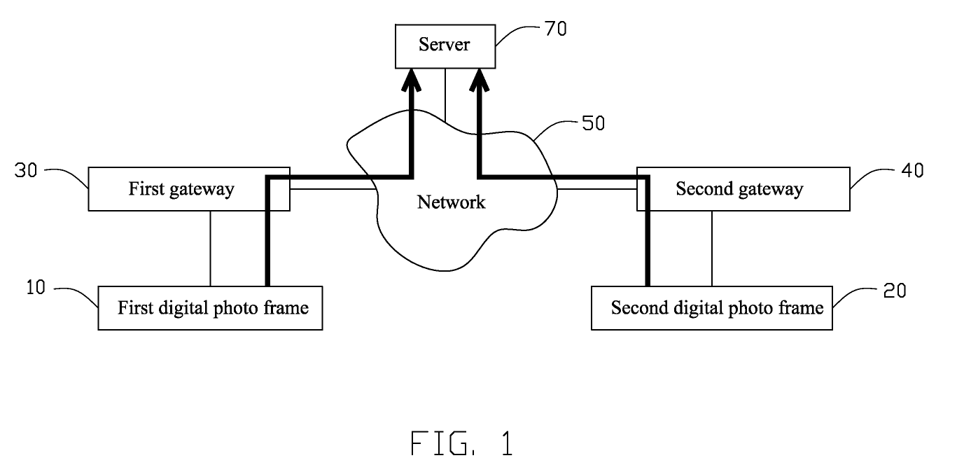

Referring to FIGS. 1 to 4, an embodiment of a peer-to-peer file sharing system includes a first electronic device, a first gateway 30 connected to the first electronic device for connecting the first electronic device to a network 50, a second electronic device, a second gateway 40 connected to the second electronic device for connecting the second electronic device to the network 50, and a server 70 connected to the network 50. In one embodiment, the first electronic device is a first digital photo frame 10, the second electronic device is a second digital photo frame 20, the network 50 may be the Internet or the local network, and so on. A plurality of media files, such as photos, videos, audios, can be stored in the first digital photo frame 10. Network information of digital photo frames connecting to the network 50 is stored in the server 70. The network information of digital photo frames includes identification information, address information, and so on, in which the identification information is the Universally Unique Identifier (UUID) of the digital photo frame, and the address information is the Internet Protocol (IP) address.

Referring to FIG. 1, when a media file in the first digital photo frame 10 needs to be transferred to the second digital photo frame 20, the UUID of the second digital photo frame 20 is required to be known. When the first digital photo frame 10 and the second digital photo frame 20 are turned on and connected to the network 50 through the first gateway 30 and the second gateway 40 respectively, the first digital photo frame 10 and the second digital photo frame 20 log on to the server 70 automatically for updating their network information.

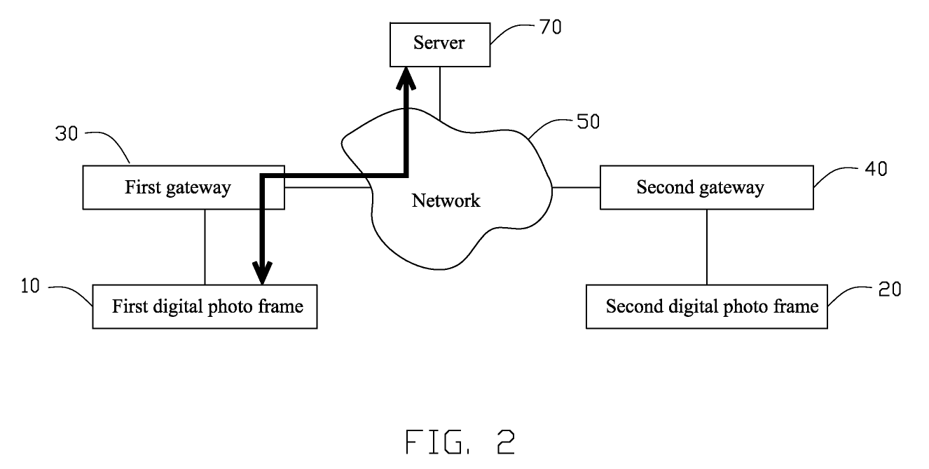

Referring to FIG. 2, the first digital photo frame 10 sends the UUID of the second digital photo frame 20 and a request destination IP for querying the IP address of the second digital photo frame 20 to the server 70. The server 70 determines whether the UUID of the second digital photo frame sent by the first digital photo frame 10 is valid, if the UUID is valid, the server 70 will send the IP address of the second digital photo frame 20 to the first digital photo frame 10 according to the request destination IP. If the UUID is invalid, the server 70 will notify that the UUID is false, and the first digital photo frame 10 will send the UUID and the request destination IP to the server 70 again.

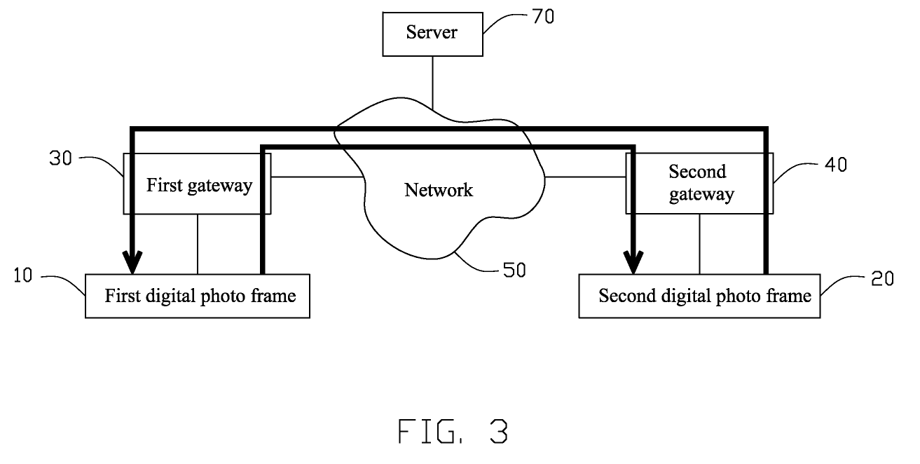

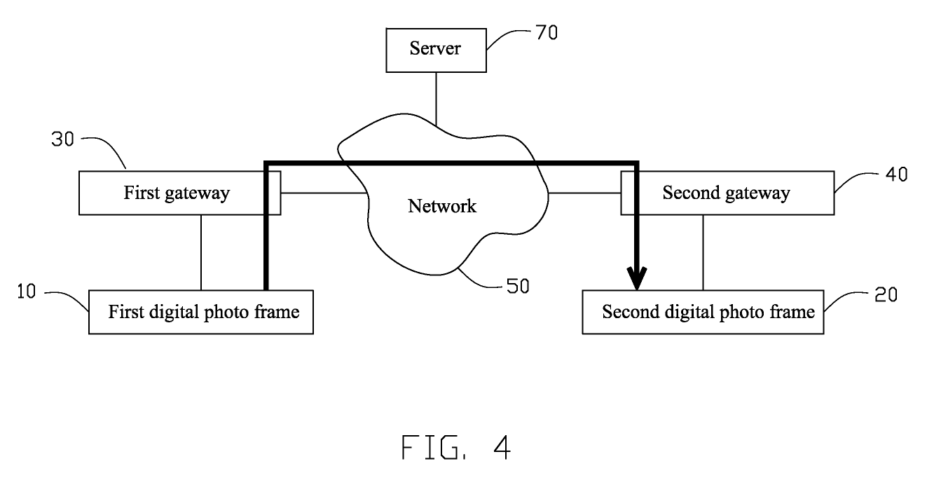

Referring to FIGS. 3 and 4, when the first digital photo frame 10 receives the IP address of the second digital photo frame 20, the first digital photo frame 10 will send a data transfer request to the second digital photo frame 20 according to the IP address, and wait for a respond from the second digital photo frame 20. When the second digital photo frame 20 receives the data transfer request, the second digital photo frame 20 will reply whether receives the media file from the first digital photo frame 10, therefore establishing the connection between the two digital photo frames 10, 20. If the second digital photo frame 20 replies yes, the first digital photo frame 10 will transmit the media file to the second digital photo frame 20 directly. If the second digital photo frame 20 replies no, the connection between the two digital photo frames 10, 20 will be disconnected. When the second digital photo frame 20 receives the media file, the media file can be browsed.

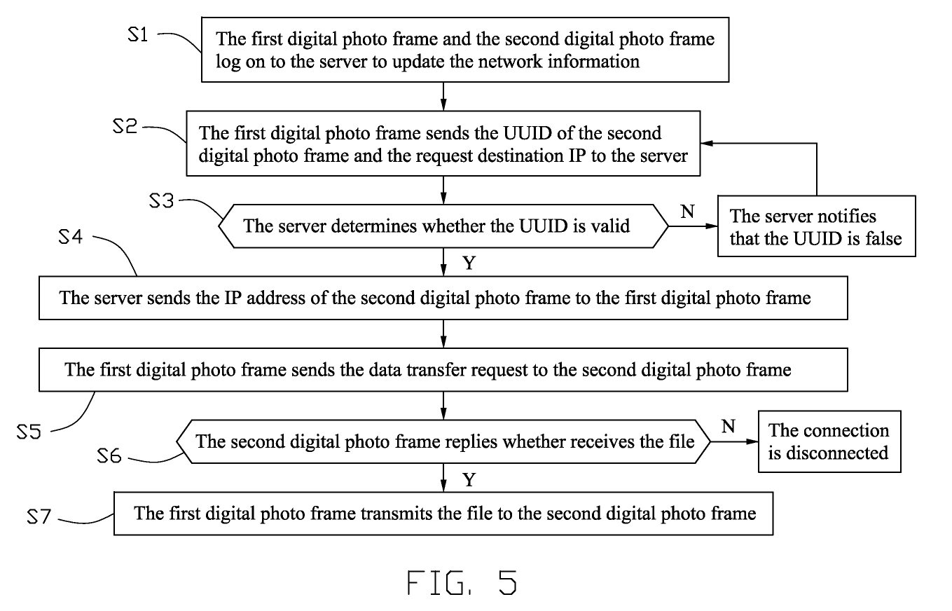

Referring to FIG. 5, a flow chart of a peer-to-peer file sharing method includes the following steps:
S1: The first digital photo frame 10 and the second digital photo frame 20 are turned on, and log on to the server 70 through the first gateway 30 and the second gateway 40 automatically to update their corresponding network information in the server 70;
S2: The first digital photo frame 10 sends the UUID of the second digital photo frame 20 and the request destination IP for querying the IP address of the second digital photo frame 20 to the server 70;
S3: The server 70 determines whether the UUID of the second digital photo frame sent by the first digital photo frame 10 is valid; if the UUID of the second digital photo frame is valid, go to step S4; if the UUID of the second digital photo frame is invalid, the server 70 notifies the first digital photo frame 10 that the UUID is false;
S4: The server 70 sends the IP address of the second digital photo frame 20 to the first digital photo frame 10;
S5: The first digital photo frame 10 sends a data transfer request for transmitting the media file to the second digital photo frame 20 according to the IP address of the second digital photo frame 20, and wait for the reply of the second digital photo frame 20;
S6: The second digital photo frame 20 receives the data transfer request, and replies to the first digital photo frame 10 whether receives the media file from the first digital photo frame 10; if the second digital photo frame 20 replies yes, go to step S7; if the second digital photo frame 20 replies no, the connection between the two digital photo frames 10, 20 will be disconnected;
S7: The first digital photo frame 10 transmits the media file to the second digital photo frame 20 directly.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A peer-to-peer file sharing system, comprising:
a first digital photo frame connected to a network, a plurality of files being stored in the first digital photo frame;
a second digital photo frame connected to the network; and
a server connected to the network, an address information of the second digital photo frame being stored in the server;
wherein the first digital photo frame is capable of acquiring the address information of the second digital photo frame from the server, and transmitting the files to the second digital photo frame directly based on the address information.

2. The peer-to-peer file sharing system of claim 1, wherein an identification information of the second digital photo frame is also stored in the server.

3. The peer-to-peer file sharing system of claim 2, wherein the identification information is the Universally Unique Identifier (UUID) of the second digital photo frame, and the address information is the Internet Protocol (IP) address of the second digital photo frame.

4. The peer-to-peer file sharing system of claim 3, wherein the second digital photo frame is configured for logging on to the server automatically and updating the UUID and IP address in the server.

5. The peer-to-peer file sharing system of claim 4, wherein the first digital photo frame is capable of sending the UUID of the second digital photo frame and a request destination IP for querying the IP address of the second digital photo frame to the server, thereby acquiring the address information of the second digital photo frame.

6. The peer-to-peer file sharing system of claim 5, wherein the server is configured for determining whether the UUID of the second digital photo frame sent by the first digital photo frame is valid, if it is valid, the server will send the IP address of the second digital photo frame to the first digital photo frame.

7. A peer-to-peer file sharing method, comprising:
logging on to a server through a network by a first digital photo frame;
acquiring an address information of a second digital photo frame from the server, wherein the second digital photo frame is connected to the sever through the network; and
transmitting a file to the second digital photo frame directly according to the address information of the second digital photo frame from the first digital photo frame.

8. The peer-to-peer file sharing method of claim 7, further comprising sending identification information of the second digital photo frame to the server by the first digital photo frame.

9. The peer-to-peer file sharing method of claim 8, further comprising determining whether the identification information is valid by the server, if the identification information is valid, sending the address information of the second digital photo frame to the first digital photo frame.

10. The peer-to-peer file sharing method of claim 9, wherein the identification information and the address information of the second digital photo frame are stored in the server, and the second digital photo frame automatically updates identification information and the address information in the server.

11. The peer-to-peer file sharing method of claim 10, wherein the identification information is the Universally Unique Identifier (UUID) of the second digital photo frame, and the address information is the Internet Protocol (IP) address of the second digital photo frame.

12. The peer-to-peer file sharing method of claim 11, further comprising sending a data transfer request to the second digital photo frame by the first digital photo frame and waiting for the reply from the second digital photo frame before transmitting the file to the second digital photo frame.

13. The peer-to-peer file sharing method of claim 12, wherein the first digital photo frame transmits the file to the second digital photo frame directly when the second digital photo frame agrees to receive the file.

14. The peer-to-peer file sharing method of claim 12, wherein if the server determines that the UUID of the second digital photo frame sent by the first digital photo frame is invalid, the server will notify the first digital photo frame that the UUID is false, and the first digital photo frame will send the UUID and the request destination IP to the server again.
